(19) United States
(12) Patent Application Publication
(10) Pub. No.: US 2010/0122170 A1
(43) Pub. Date: May 13, 2010

(54) SYSTEMS AND METHODS FOR INTERACTIVE READING

(76) Inventors: Charles Girsch, Denver, CO (US); Maria Girsch, Denver, CO (US); Travis Millman, Stamford, CT (US)

Correspondence Address: SCHWEGMAN, LUNDBERG & WOESSNER, P.A., P.O. BOX 2938, MINNEAPOLIS, MN, 55402, US

(21) Appl. No.: 12/618,671

(22) Filed: Nov. 13, 2009

Related U.S. Application Data
(60) Provisional application No. 61/114,188, filed on Nov. 13, 2008.
(60) Provisional application No. 61/164,747, filed on Mar. 30, 2009.

(51) Int. Cl. G06F 3/048; G06F 3/16

(52) U.S. Cl. 715/727; 715/776; 715/771; 715/856

(57) ABSTRACT

A method of interactive reading may include generating a user interface. The user interface may include audio data and video data received from a first user device and audio data and video received from a second user device. Additionally, a selection of a book from the first user device is received. A graphical representation of the book comprising text and illustrations from the book is displayed on the user interface, wherein the book is presented a single page at a time. An indication from the first user device or second user device to proceed to a second page of the book may be received the user interface may be updated to present the second page of the book. Also, the user interface may be transmitted to the first user device and the second user device. The method may also include a recording of the audio and video data sent by the user devices to be played back later.

### RELATED APPLICATIONS

This application claims the benefit of priority under 35 U.S.C. Section 119(e), to U.S. Provisional Patent Application Ser. No. 61/114,188, filed on Nov. 13, 2008, and to U.S. Provisional Patent Application Ser. No. 61/164,747, filed on Mar. 30, 2009, which are incorporated herein by reference in their entirety.

### BACKGROUND

Presently, there exists tools that allow people to communicate over great distances. Digital versions of books also are being used in place of physical books.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever

### BRIEF DESCRIPTION OF THE DRAWINGS

Some example embodiments are illustrated by way of example and not limitation in the figures of the accompanying drawings in which:

FIG. 1 is a diagram of a system, according to an example embodiment, for sending and receiving audio.

FIG. 2 is a block diagram of a server device, according to an example embodiment.

FIG. 3 is a block diagram of sample webpages, according to an example embodiment.

FIG. 4 is a block diagram of an account database, according to an example embodiment.

FIG. 5 is a block diagram of an online library database, according to an example embodiment.

FIGS. 6-8 are flowchart diagrams of methods of transmitting audio, according to an example embodiment.

FIGS. 9-16 are example webpages, according to an example embodiment.

FIG. 17 is a flowchart diagram of a method of transmitting audio, according to an example embodiment.

FIG. 18 is a diagram illustrating example connections and functionality between example webpages, according to an example embodiment.

FIG. 19 is a computer system, according to an example embodiment.

FIG. 20 is a flowchart of an example method, according to an example embodiment.

FIG. 21 is a system diagram, according to an example embodiment.

FIG. 22 is an example user interface according to an example embodiment.

FIG. 23 is an example user interface to choose a role, according to an example embodiment.

FIG. 24 is an example user interface to choose a book, according to an example embodiment.

### DETAILED DESCRIPTION

The following detailed description of the present subject matter refers to the accompanying drawings which show, by way of illustration, specific aspects and embodiments in which the present subject matter may be practiced. These embodiments are described in sufficient detail to enable those skilled in the art to practice the present subject matter. Other embodiments may be utilized and structural, logical, and electrical changes may be made without departing from the scope of the present subject matter. References to “an,” “one,” or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

In various other embodiments, a reading experience may be enhanced by allowing an interactive reading experience between more than one participant over a network connection. For example, there may be a remote shared reading experience, a karaoke reading experience, and a hot spot enabled reading experience. Audio data, cursor data, and video data may all be gathered from one or more user device (e.g., personal computers) and presented on a unified user interface. In some embodiments, the user interface is restricted to being controlled by one user. For example, a parent may wish to control the experience. The embodiments discussed below may be combined with the methods for sending and receiving audio disclosed below. In further embodiments, users of the reading system may create their own books that may be read interactively.

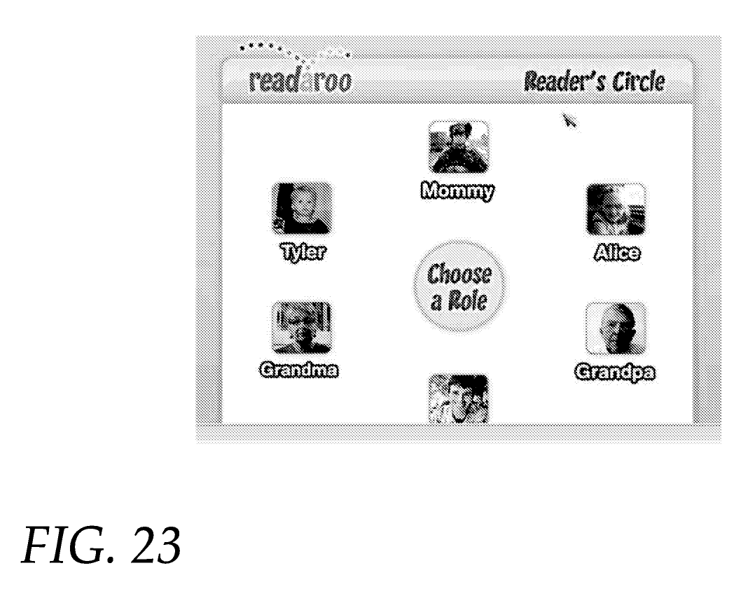

In a remote shared reading embodiment, two or more people read a book online together at the same time. Additionally, if a user has a video device, video may be shared alongside a digital version of the book. In some example embodiments, only one of the users has a video camera. In an embodiment, in an account/profile creation interface a user signs up for the service and creates user names (optionally with passwords) and profiles (including photos, roles, etc.) for grandma, children and other family/friends. An example user interface for selection a role is illustrate in FIG. 23. In some embodiments, the creation of such accounts results in an email invitation to a personalized launch page that contains both a shared library of books and a list of contacts. The remote shared reading experience also has various components to foster an immersive experience.

For example, in an embodiment, there is a dual book interface and people choose function. This may be in a unified user interface allowing a user to choose which book to read or which reading partner to read with, in any order. In other words, a fluid interface is presented allowing the adding and subtracting of participants at multiple points in the experience. Further, during the selection period video and audio may be shared so that the users can hear and see the other participants. Also, cursor positions of the user's input devices (e.g., a mouse) are shown to the other participants such that a complete real-time experience is shared among all of the connected participants.

Additionally the user interface may provide a shared whiteboard like experience by having animations on click or other user input. For example, clicking one's mouse over a “book content” button may result in one or more animations intended to convey to the other user(s) that the clicker has “chosen” an object or a particular book content location.

In various embodiments, the interface allows book view mode toggling. For example, a single toggle button that, when activated, switches from a two-page spread view mode to single page view mode and repositions video and A/V/navigation controls at the same time. This may be helpful in situations where a book is oriented with tall pages. Additionally, there may be a record button that records video, audio, mouse movements and page-turning as a unified session experience. This may allow sharing as described in previous embodiments.

In further example embodiments a “Readioke” experience is presented which blends reading and karaoke. There may be speech input driven trigger points where the notion of word or sequence of word based “trigger points” coming from a recognized speech signal for audio (music and/or sound effect) playback. In another example there is the notion of an “audio loop” that is triggered (started) by a speech-driven trigger point and subsequently stopped by another one.

In an example embodiment, there is remote narration creation and consumption. For example, making a recording and sending it to a reader in a remote location. Further embodiments allow a user to upload documents related to the book. For instance, a recording of a performance given at a school, or homework assignments. Other examples may include writings, news stories, or art concerned with a book.

In further embodiments, there may be Ad-hoc “follow the bouncing ball” or real-time text highlighting used as a guided reading indicator. Using a recognizable speech input, the embodiment can provide real-time highlighting, bolding or bouncing ball indicator such that an early reader can benefit from visually observing the association of a proficient reading partner's reading aloud and the text of a book (on the screen).

Additionally the embodiments may be combined to offer users the ability to create their own music, sound effect and/or audio loops via a drag-and-drop interface that allows the placement of such triggers vis-à-vis specific words or sequences of words in the text.

In various embodiments hotspots are embedded in a book by enabling user created hot spots for arbitrary book content. Such hot spots may be made visible or invisible at “run time” (e.g. reading time) at the preference of their creators and/or consumers. In an example, music clips, recordings and/or sound effects may be added to the hotspots via the use of a simple drag-and-drop interface. For example, a child may define a hotspot around a cat by outlining it with her mouse and then assign a recording of a cat to be played when she (or someone else) mouses over or clicks on that cat. Similarly, a recording (made before or after the creation of the hotspot) of that child saying, “meow” might also be so assigned.

In various embodiments, everything from the hotspots themselves to the audio effects assigned to them might be shared with other users of the shared reading system, whether they are known or unknown to the user that created them. In an embodiment, the user will have control over who gets to access/consume their hotspots.

In various embodiments participants may edit a book directly. For example, users may “doodle” over book content by treating such book content enhancement as an additional “layer” that doesn't directly impact the underlying book content. Once again, such enhancement layers may be shared with other users, with the creator's (or her parents') permission. Similarly, entire elements (e.g. a drawing of a cat) might be replaced with the users own creation(s). In further embodiments, discussion points may be presented to one user (e.g., a parent), but not to another user (e.g., a child) to foster collaboration.

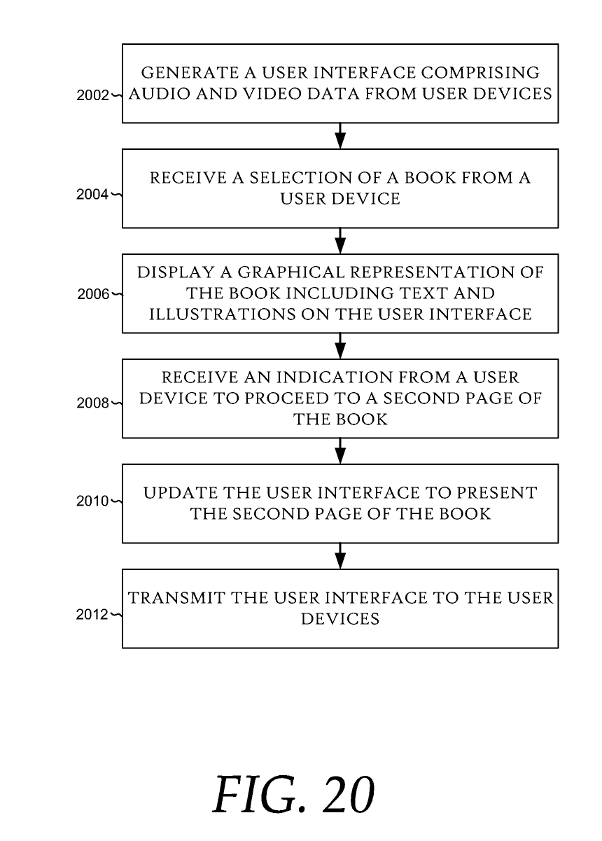

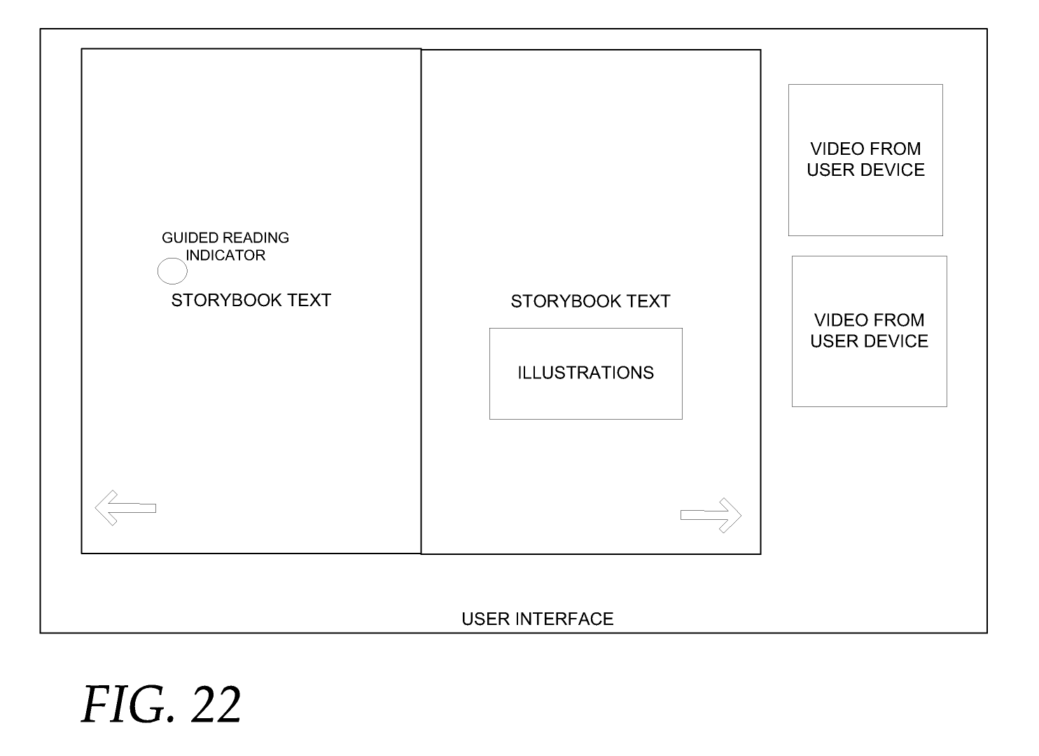

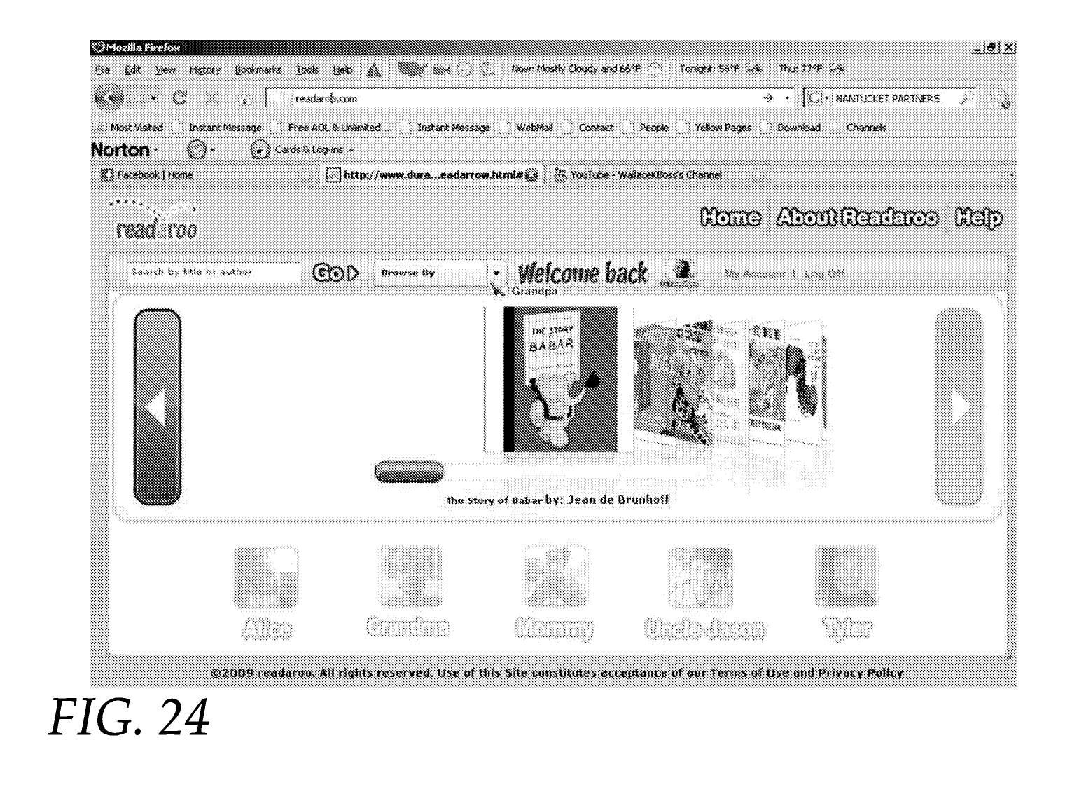

FIG. 20 illustrates an example method using some the concepts of the interactive reading experience. FIG. 22 illustrates an example system overview of an example method. At block 2002, in an example embodiment, a user interface is generated, wherein the user interface comprises audio data and video data received from a first user device and audio data and video received from a second user device. The audio data may be the voices of the participants and the video may be video of the participants. The audio and video data may be sent in real-time. This may be done at a server device as discussed above. An example of a user interface is shown in FIG. 22. At block 2004, in an example embodiment, a selection of a book is received from a first user device. FIG. 24 illustrates an example interface for choosing a book. FIG. 24 illustrates a browse by option, a link to a user's account, the name of the account, and a cursor showing the name of the user (in this case Grandpa). Further illustrated are additional users, but they are dimmed signifying they are not currently connected. In an embodiment, once a user signs on their picture is activated and their cursor shows up on all currently connected users.

At block 2006, in an example embodiment, a graphical representation of the book comprising text and illustrations is displayed on the user interface. In an example embodiment, this means that the user interface is being updated at the server device which is transmitting it back to the user devices. In further embodiments, the overall user interface may be maintained at one of the user devices such that a user device acts as a server. In an embodiment, the text includes legal information as discussed in previous embodiments. The graphical representations of the book may be stored in the server device in memory.

At block 2008, in an example embodiment, an indication is received from a user device to proceed to a second page of the book. This may be done, for example, by a user clicking on an arrow or other button on the user interface.

At block 2010, in an example embodiment, the user interface is updated to present the second page of the book. This does not mean that it literally must be the second page of the book, but simply may be the next page.

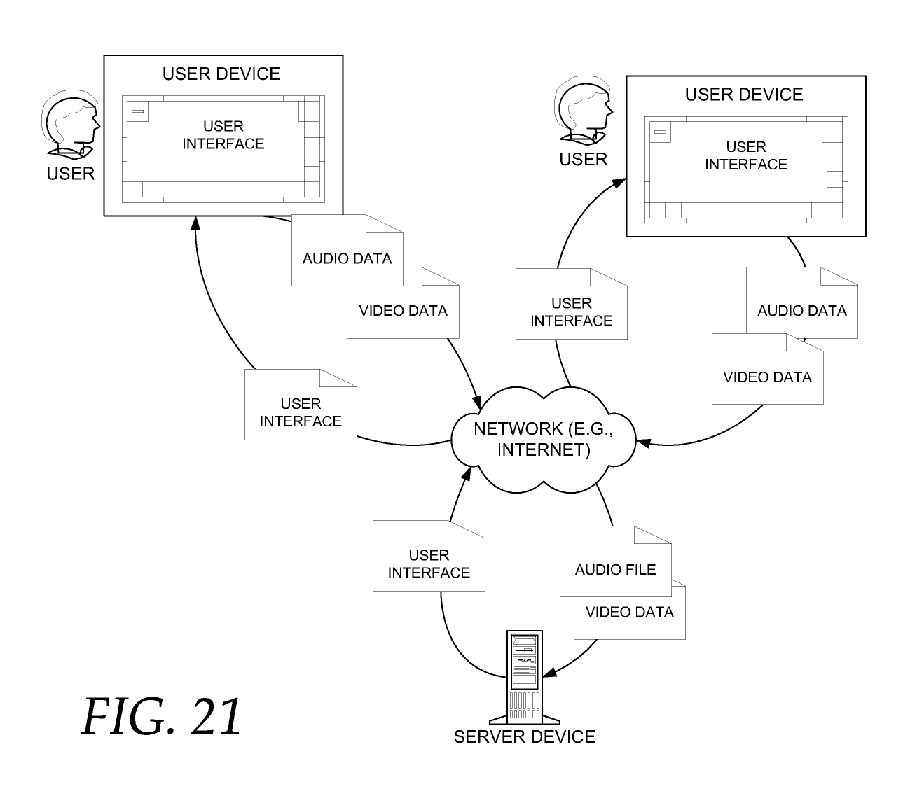

At block 2012, in an example embodiment, the user interface is transmitted to the user devices. As indicated above, the system may operate in real time such that when the audio and video data is received at a service device the user interface is updated and transmitted in real-time back to the user devices. FIG. 21 illustrates an example configuration with two user devices and one server device. As illustrated, audio/video data from both user devices is transmitted to the server device which is combined with the digital version of the book in a user interface at the server device. The user interface is then transmitted back to the user devices and displayed/played on the user devices' respective displays and audio outputs.

FIG. 22 illustrates an example user interface. Shown is a two page design with text on both pages. There is a guided reading indicator shown as a circle. Also shown are two video boxes that may contain video from the user devices. Further illustrated are back and forward arrows that may be used to navigate through the book.

Method to Record and Send Audio

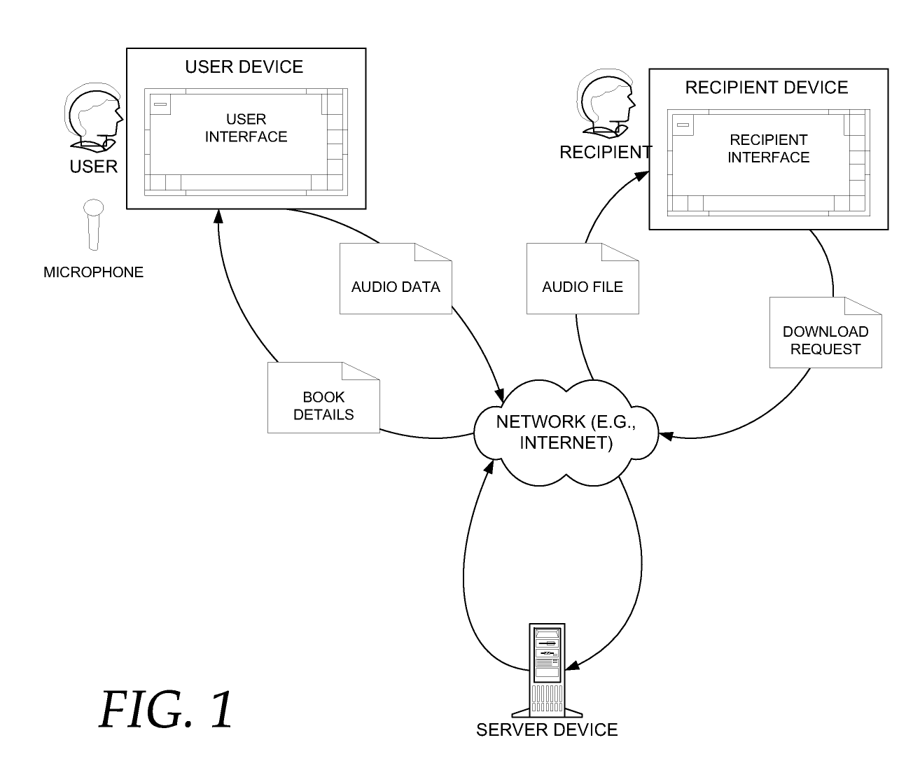

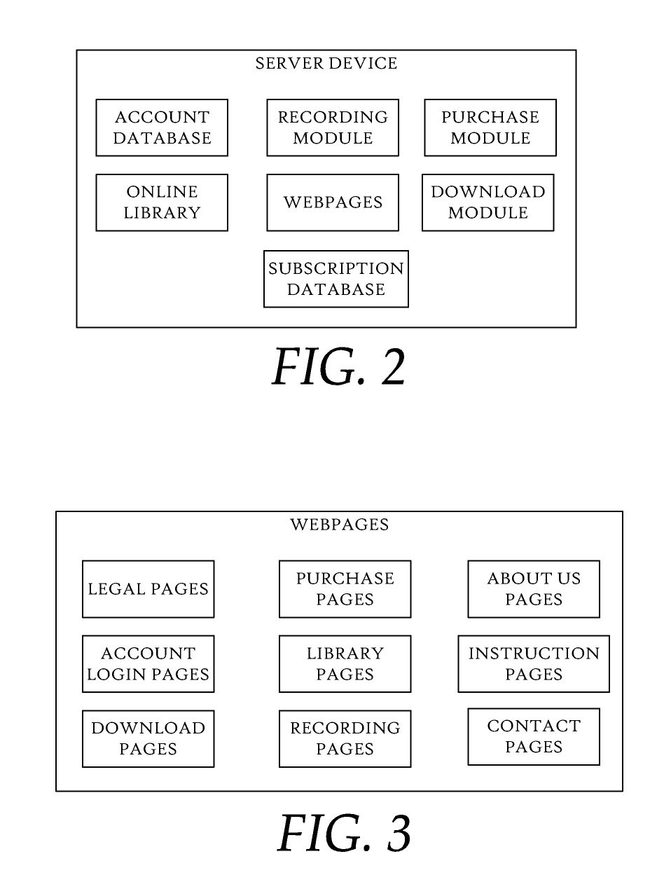

An example of a system used to record and send audio is illustrated in FIG. 1. Shown is a server device that may communicate with one or more user devices and one or more recipient devices. The server device may contain one or more modules as illustrated with reference to FIG. 2. The server device may have many functions, including, but not limited to, controlling the interactions between the user and recipient devices, storing account information, serving webpages, storing book information, processing order information, processing audio downloads, processing audio recordings, and storing legal information.

Each user device may have a microphone, or if one is not available, the system may arrange to have a user secure a microphone. The user device may be a personal computer, personal digital assistant, mobile phone, etc. The user may interact with the server device through a network (e.g., the Internet) by using a user interface such as a web browser or downloadable application. Similarly, a recipient device may be a personal computer, personal digital assistant, mobile phone, etc. A recipient may interact with the server device through a network by using a user interface such as a web browser or a downloadable application. A recipient may also be a user and vice versa. Audio data may be sent from the user device to the server device and book details may be sent from the server device to the user device. More information may be exchanged between the user device and server device, including, but not limited to, payment information, login information, and virtual library information. A download request may be transmitted from the recipient device to the server device and an audio file may be transmitted from the server device to the recipient device. More information may be exchanged between the recipient device and the server device including, but not limited to, recommendations, book details, login details, and payment information.

As discussed above, users and recipients may interact with the system in a myriad of ways, including, but not limited to a web browser and a downloadable application. In some embodiments, the user interface of the downloadable application and the user interface of the web browser provide a consistent look and feel. The downloadable application may be developed using cross-platform programming frameworks including, but not limited to, Java, Adobe Air, Adobe Flash, and Microsoft Silverlight. The downloadable application may also be developed by using more traditional programming languages such as C and C++. The application may provide the option to utilize certain aspects of the system while not being connected to a network. For example, a user may record audio using the application even when the user is not connected to the Internet. The next time the system detects that the user has reestablished an Internet connection, the application may transmit the audio data to the server device. Data associated with the application may be synchronized with data associated with data stored on the server device once the connection has been reestablished. In this manner, users may be assured that no matter which interface is used, users have access to the most current data associated with their accounts.

In an example embodiment, the server device shown in FIG. 1 may have further details as illustrated in FIGS. 2-4. The server device may have one or more modules to perform the various example methods described herein. A purchase module may process an order for a user account with the order including a selection of a data item to record. A recording module may receive audio data associated with the data item and convert the audio data into an audio file. A download module may transmit the audio file to a requested recipient. Contact information for the requested recipient may be stored in an account database.

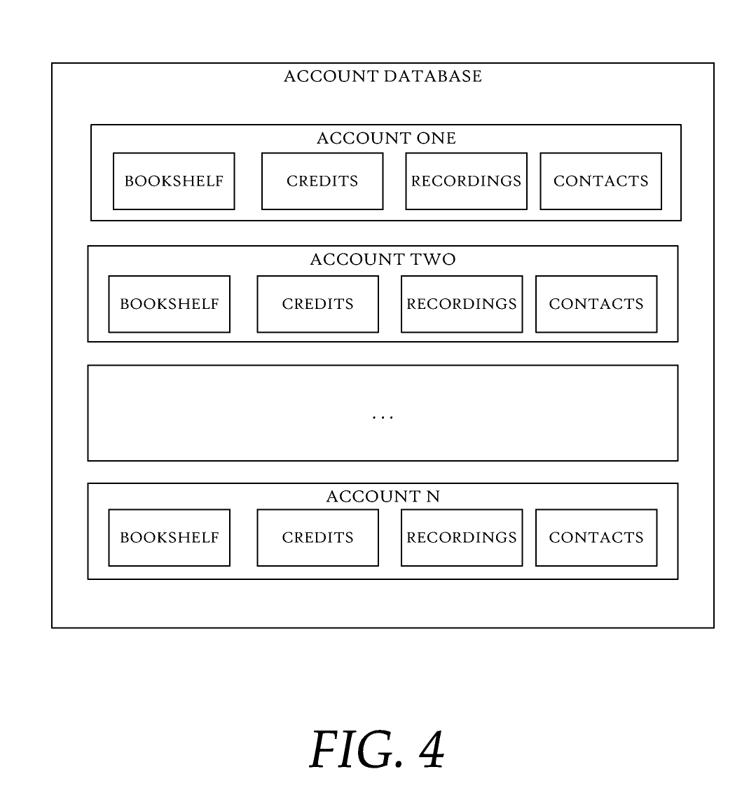

In an example embodiment, the account database includes a user account as illustrated in FIG. 4. The user account may include virtual bookshelf data, the virtual bookshelf data including data items purchased associated with the user account; credit data, the credit data including the number of credits available to the user account; recording data, the recording data including audio files received associated with the user account; and contact data, the contact data including available recipients.

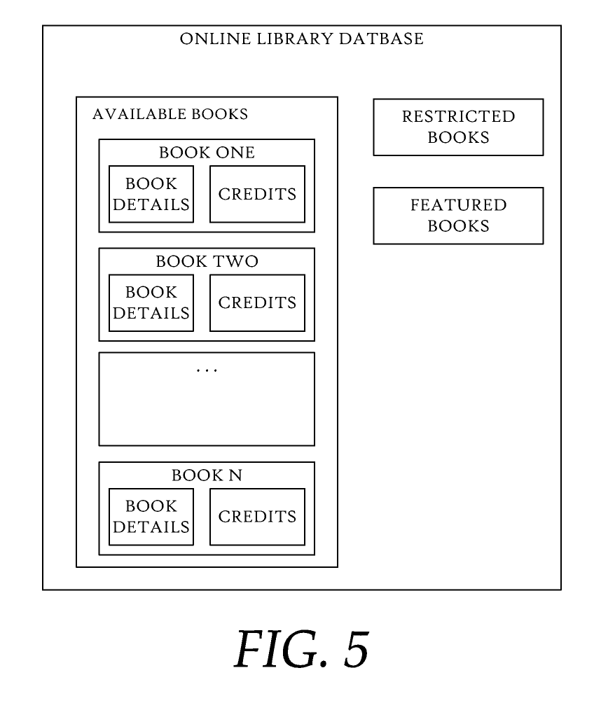

The server device may include an online library database as described in FIG. 5. The online library database may include one or more restricted data items, one or more featured data items, and one or more available data items. Restricted data items may be those items in which a publisher has decided to not allow people to record audio for its products. Similarly, featured books may be those in which a publisher has paid the owner or administrator of the system to prominently display its products. The one or more available data items may include a first available book. In an example embodiment, the first available book may include book details, and a number of credits required to purchase the book.

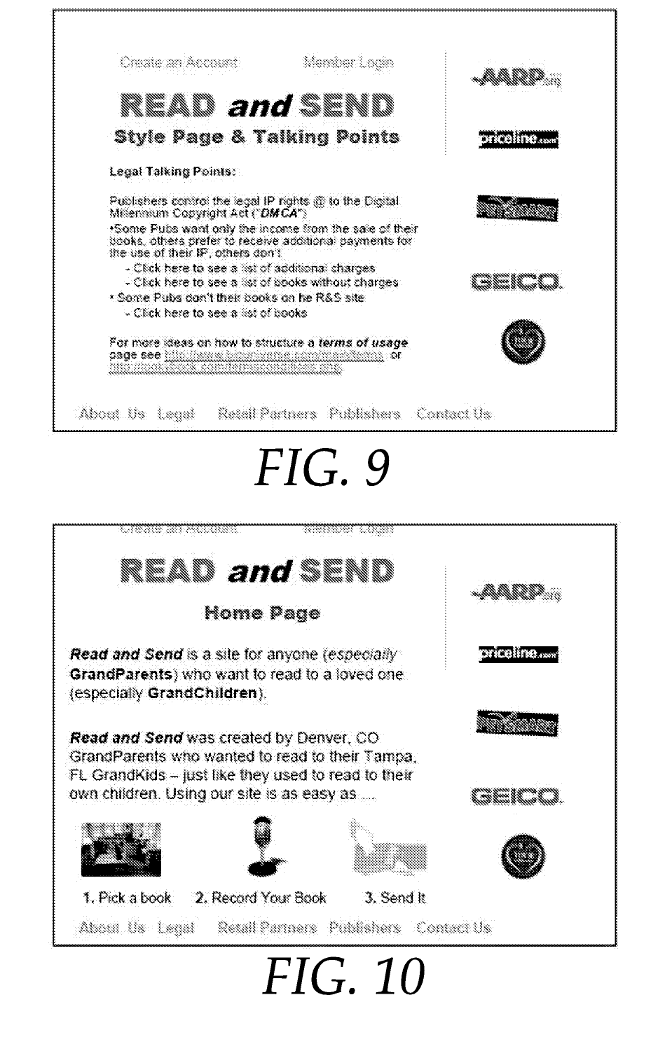

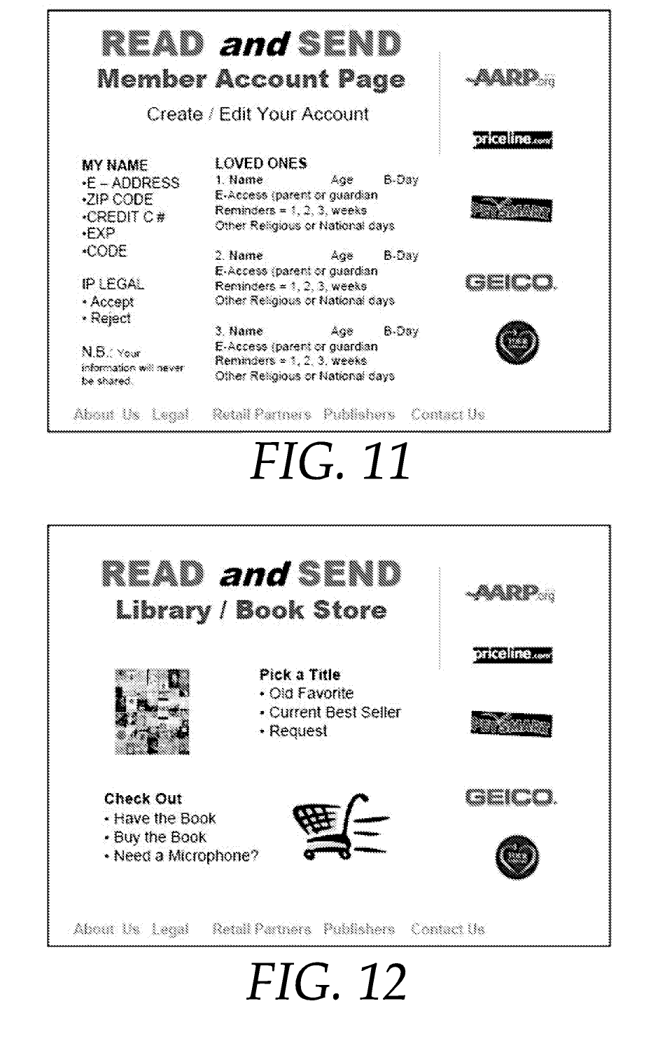

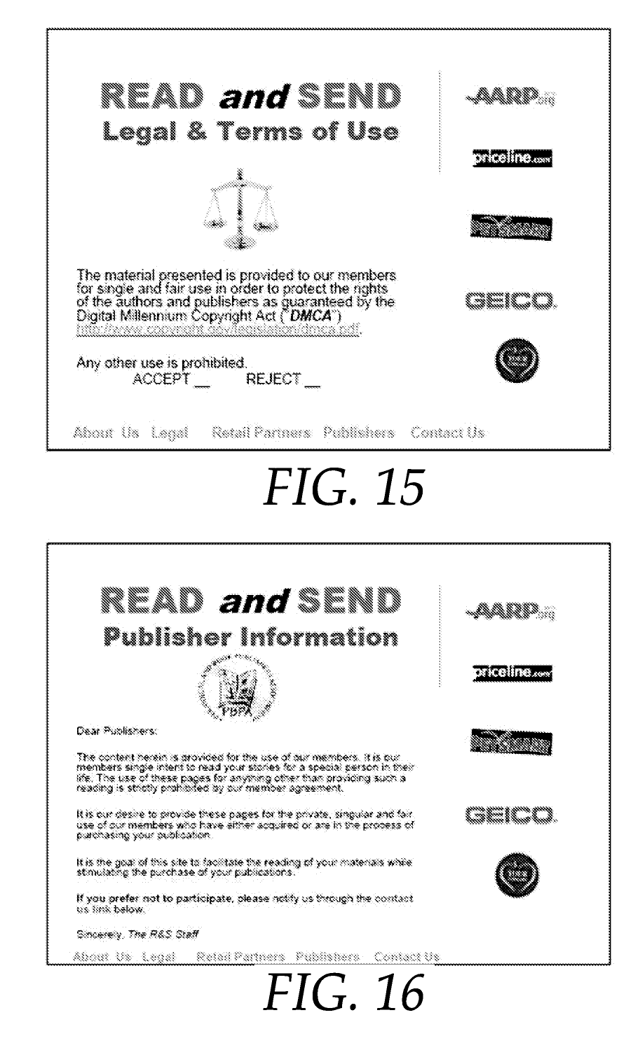

In an example embodiment, the server device includes a webpage module, the webpage module including one or more webpages available to transmit to a user device as shown in FIG. 3. The one or more webpages may include a legal webpage, the legal webpage including legal contract information. Other webpages may include, purchase pages, “about us” pages, account login pages, library pages, instruction pages, download pages, recording pages, and contact (e.g., recipient) pages. Example webpages are illustrated in FIGS. 9-16.

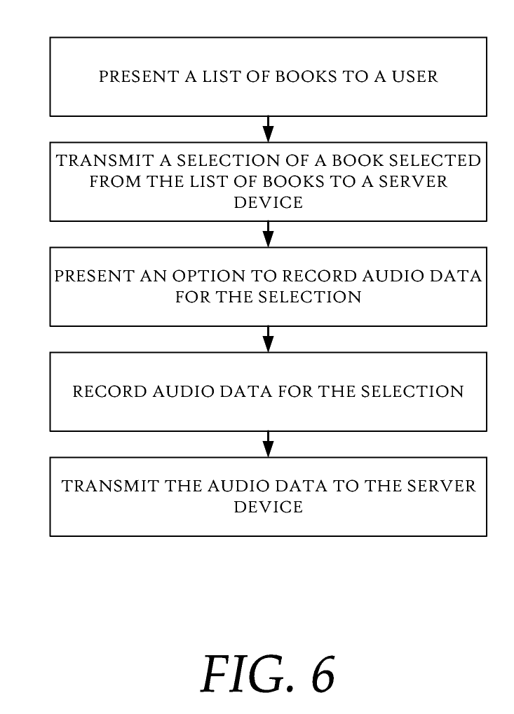

An example embodiment is diagrammed in FIG. 6. In an example embodiment the blocks shown may be implemented using a system as shown in FIG. 1. In an example embodiment a list of books is presented to a user. While the use of books is commonly used in this application, other types of media may also be presented such as magazines or other readable mediums that a user may wish to record. The books may be presented in the form of a webpage presented to the user on a user device. The books may be graphically or textually presented. Also, the number of books shown may be changed by the user. Book data for the selection may be presented, the book data including a number of credits required to purchase the book. In an example embodiment each book has a credit value of greater than or equal to zero. A user may purchase credits through the server device. The system may also use a more traditional dollar based pay system. The book data may include publisher data associated with the selection. This may include, for example, ISBN numbers and copyright information. In an example embodiment the user may sort the list of books according to user preference data. The user preference data may include the frequency of sale of the books. It may also include, but is not limited to, genre or year of publication.

Further illustrated, is transmitting a selection of a book selected from the list of books to a server device. A user may select a book in any suitable way including but not limited to, checking a checkbox, clicking an “add to cart” link, or clicking a presented button indicating the user wishes to add the book to his or her digital library. The digital library may include the previous books that have been selected by the user.

In an example embodiment, an option to record audio data for the selection is presented to the user. This may be presented as an additional option beyond the user selecting a book. In additional embodiments, selecting the option to record the audio data may be sufficient to select the book. In an example embodiment, the option to record the audio data is not presented until after the user has selected a book and the order has been processed.

In an example embodiment, legal information associated with recording audio data for the selection may be presented. The legal information may include a legal warning that explains what a user may and may not do with any resulting recording. The information may include, for example, portions of the Digital Millennium Copyright Act. Legal information may also be presented to publishers. Example pages containing sample legal language are illustrated in FIGS. 9-11.

In an example embodiment, an indication of acknowledgment of the legal information is received. As shown in FIG. 10 the indication may result from the user selecting the “Accept” option. Other options may include having a user check a checkbox or any other suitable method in which a user has to take an affirmative step signifying the user has agreed to the legal terms. The indication may be transmitted to the server device (e.g., via the Internet). This indication may be stored in an account associated with the user. If the user indicates that he or she does not accept the legal information, a message may be displayed informing the user that he or she may not record or send any audio until he or she accepts the legal terms presented.

In an example embodiment, a list of intended recipients is transmitted to the server device. This may include the server device presenting a form in which the user may create a list of intended recipients. Each recipient in the list may have a name, e-mail address, phone number, birthday, etc., that is entered into the form by the user. An example list of recipients is shown in FIG. 12. The system may send reminders to the user when a recipient's birthday is within a predetermined time period of the current date (e.g., 1 week, 2 weeks).

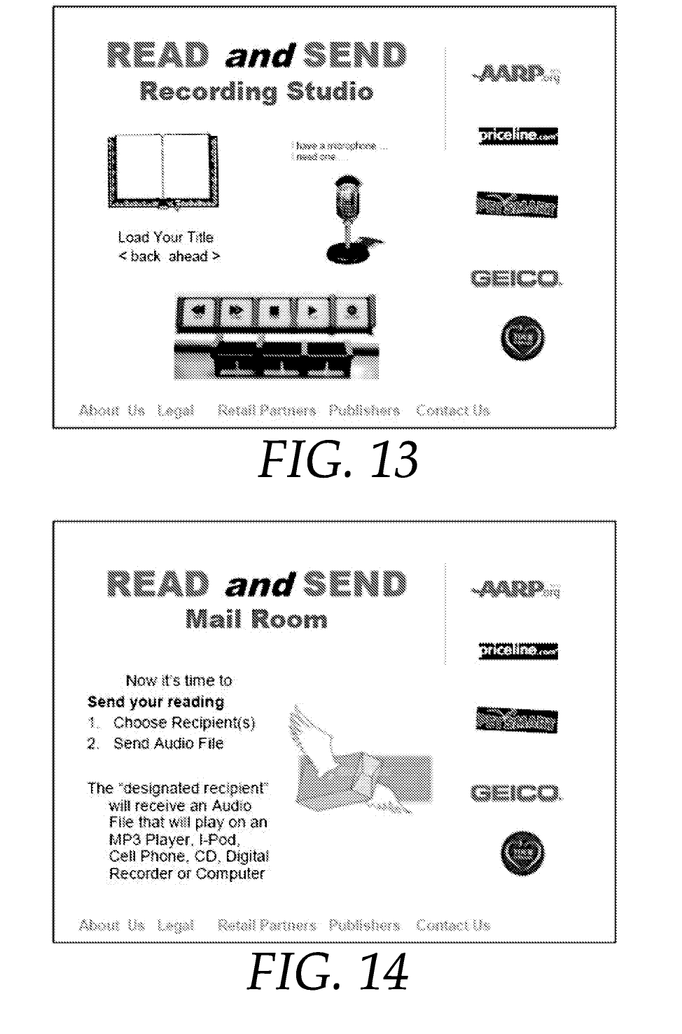

In an example embodiment, audio data for the selection is recorded. In an example embodiment, a user may be presented with a list of purchased books that are waiting to be recorded. The user may choose whether to record the most recently purchased book or any other previously purchased book. Once the selection has been made, a screen may be presented to the user with instructions on how to record the audio (e.g., FIG. 13). The user may use an external microphone connected to the user device or an internal microphone embedded in the user device. There may be controls that allow the user to rewind, fast-forward, pause, and play the recorded audio. This may allow the user to correct any portions of the audio recorded. Other possible controls may allow the user to skip to certain portions of the selected book. In an example embodiment, the audio data is transmitted to the server device. This may be done as the user is talking into the microphone such that the audio is stored on the server device as the user is reading the book. The audio may also be recorded on the user device and once the user indicates he or she is finished, the resulting data file may be transmitted to the server device. The audio may be stored in any one or more suitable formats including, but not limited to, MP3, AIFF, and WAV. In an example embodiment, a digital copy of the selection may be presented to the user on the user device. This may, for example, include displaying scanned pages of the book to the user.

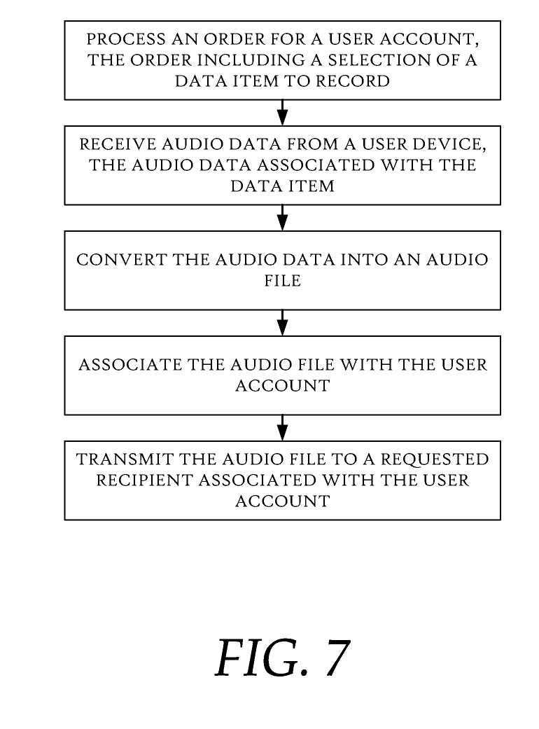

An example embodiment is illustrated in FIG. 7. Login information from the user device may be received at the server device. The login information may include a user name and password. The login information may be verified. This may be done by comparing the login information to account information stored on the server device. If the verification is successful, access may be granted to data associated with the user. The data associated with the user account may include potential recipients. It may also include access to account settings including payment methods and the user's virtual library.

In an example embodiment, an order is processed for a user account. The order may include a selection of a data item to record wherein the data item includes a book. As discussed above, other items may also be recorded beyond books. It may also be possible for a user to indicate he or she will be recording a personal message. A list of available data items may be transmitted to the user device such as, for example, a list of books. Further, a digital copy of the book may be transmitted to the user.

In an example embodiment, audio data from a user device is received, and the audio data may be associated with the data item. As discussed above, recording instructions may also be transmitted to the user. Further, the audio data may be converted into an audio file. In an example embodiment, the audio file is associated with the user account. This may include storing the audio file in a virtual bookshelf for the user account. The resulting audio file may be transmitted to a requested recipient associated with the user account as well as transmitted to the user. It may also be possible to send a copy of the book to the requested recipient. This may include the physical book, the digital copy, or both.

In an example embodiment, credit data associated with the user account is retrieved. The credit data may include the number of credits available to the user. These credits may be purchased ahead of time using any suitable payment method including, but not limited to, credit card, electronic checking, or utilizing a third-party service. Traditional currency amounts may also be used in place of credits. Purchase information for the data item may be retrieved. For example, the purchase information may include the number of credits required to record the data item. If the user decides to purchase or record the data item, the number of credits required to record the data item may be deducted from the number of credits available to the user. If the user does not have sufficient credits to record the data item, a message informing the user may be presented to the user with the option to purchase more credits.

As discussed above, one or more legal agreements may be transmitted to the user device. An indication the user has agreed to the one or more legal agreements may be received and the indication the user has agreed may be stored in the user account.

In an example embodiment, a recommendation of a data item to record may be transmitted to the user device. The recommendation may include a data item recommended by the requested recipient. In this manner there may be more interaction between the user and the recipient than sending and receiving the audio file. In an example embodiment, a recipient may purchase a book for the user and when the user signs into the system, a message may be presented that a book has been purchased for him or her.

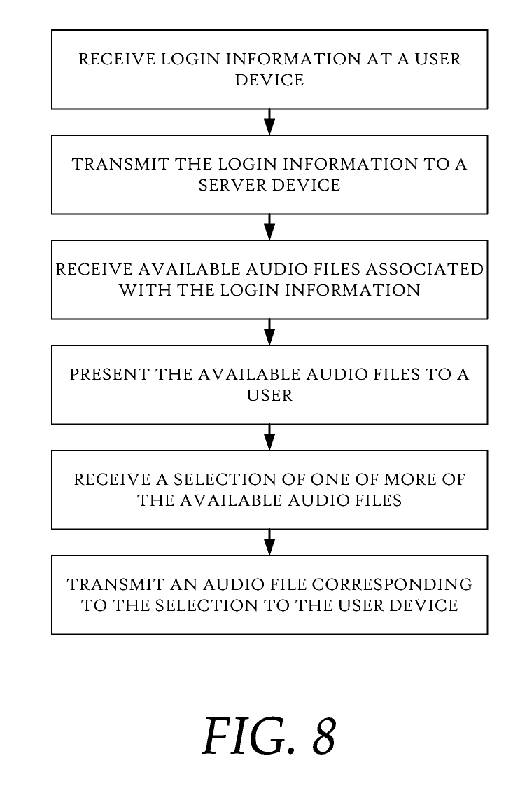

Illustrated in FIG. 8 is another method of using the system, according to an example embodiment. Login information may be received at a user device. The login information may transmitted to a server device. Available audio files associated with the login information may be received and the available audio files may be presented to a user. A selection of one or more of the available audio files may be received and an audio file corresponding to the selection may be transmitted to the user device. The audio file may be mailed to the user. This may involve, for example, burning the audio file to a compact disc. A digital representation of the audio file may be presented to the user. The digital representation may include, for example, pages of a book.

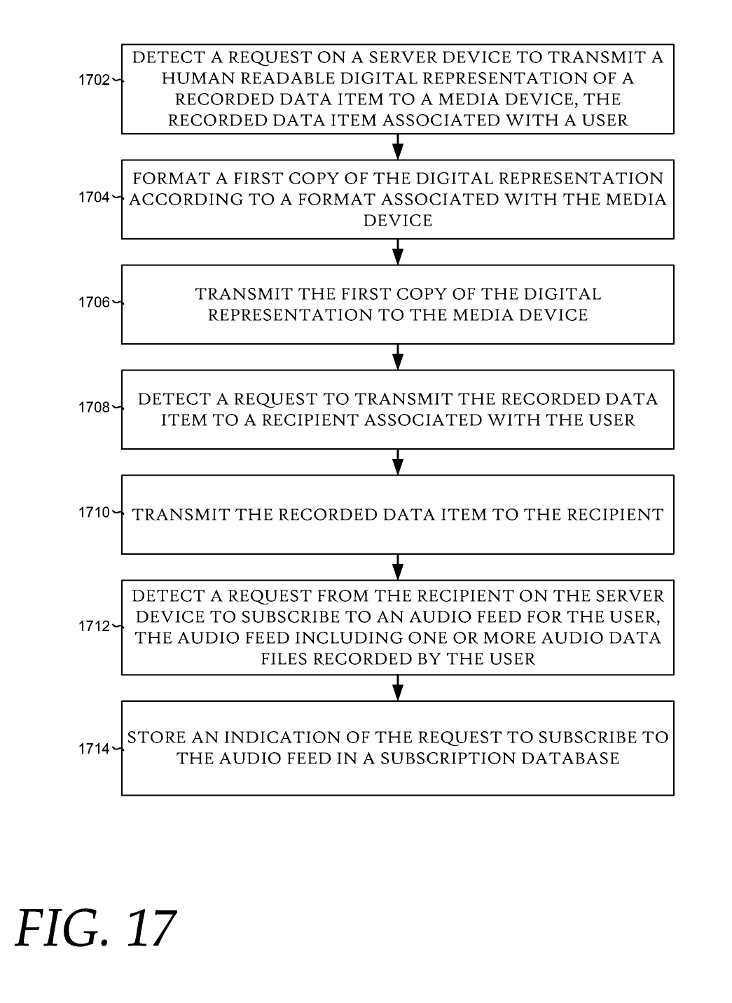

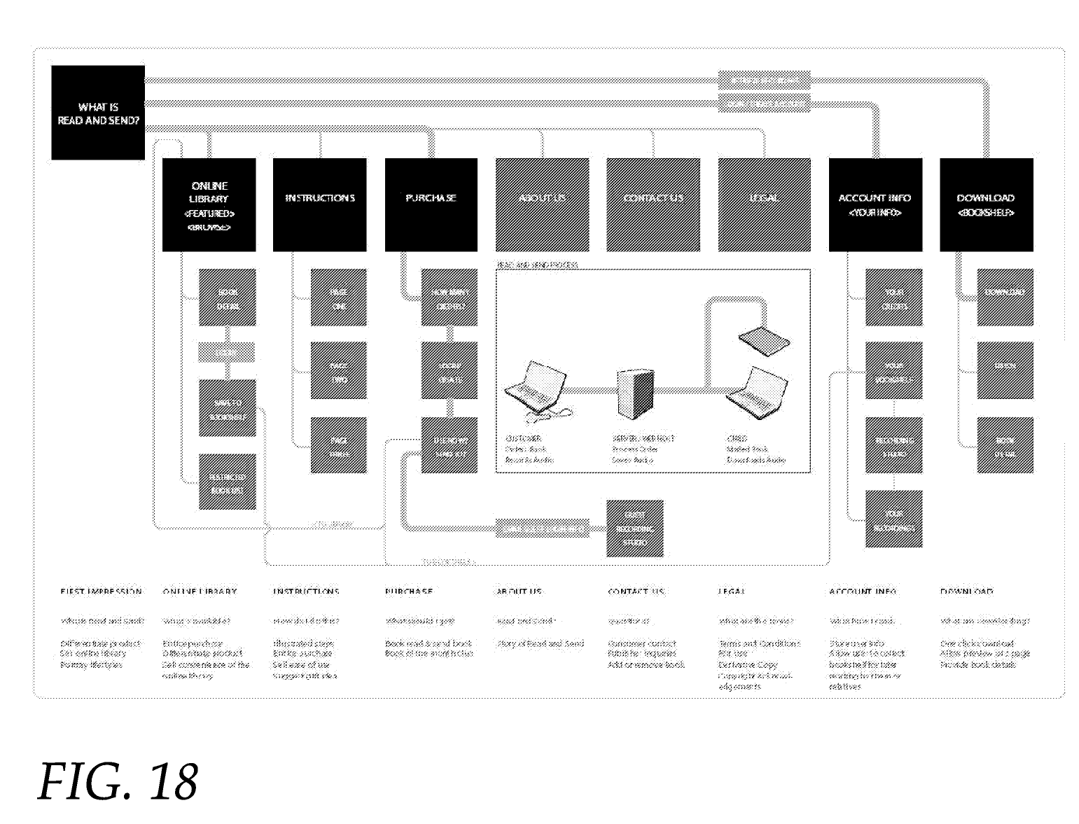

Illustrated in FIG. 17 is a flowchart describing an example method of using the system, according to an example embodiment. At block 1702, a request on a server device to transmit a human readable digital representation of a recorded data item to a media device may be detected, the recorded data item associated with a user. As discussed above, the data item may be a book. In some examples, the human readable digital representation may be a PDF, an image file, or a Word Document. In an example embodiment, a media device may be an electronic book reader. For example, the media device may be the Kindle (sold by Amazon.com). In one example embodiment, the media device may be a mobile phone with a display capable or presenting the digital representation or a personal media player such as an iPod (sold by Apple). In further embodiments, the media device may be a personal digital assistant.

In an example embodiment as shown at block 1704, a first copy of the digital representation is formatted according to a format associated with the media device, and at block 1706, the first copy of the digital representation is transmitted to the media device. For example, a plurality of media devices may be presented to the user on a user device. The system may detect a selection of a first media device from the user (e.g., selecting a check box, clicking an image of the media device, etc). The system may then format the digital representation into the format associated with the media device. In some example embodiments, the system may not have the necessary legal rights to the format. If possible, a request may be made to a 3rd party to acquire the properly formatted digital representation.

At block 1708, in an example embodiment, a request to transmit the recorded data item to a recipient associated with the user is detected, and at block 1710 the recorded data item is transmitted to the recipient. As discussed above with reference to FIG. 7, this may allow the user to send the audio to one or more recipients. For example, if the user is a grandparent, the grandparent may wish to send a copy of a recorded holiday story to all of his or her grandchildren.

In an example embodiment, preference data associated with a recipient may be retrieved including a preferred media device. A second copy of the digital representation may be formatted according to a format associated with the preferred media device and transmitted to the preferred media device. In this manner, if there are multiple recipients, each recipient will receive the digital representation in a proper format.

At block 1712, in an example embodiment, a request from the recipient on the server device to subscribe to an audio feed for the user is detected, the audio feed including one or more audio data files recorded by the user. At 1714, an indication of the request to subscribe to the audio feed may be stored in a subscription database. In an example embodiment an audio feed is constructed for each user in the system. In an example embodiment, the audio feed may be a Really Simple Syndication (RSS) feed, Atom feed, or other suitable electronic syndication format. The system may query the subscription database each time the user records another data item and notify the subscribed recipients. In some embodiments, the system automatically transmits the new audio file to the recipients. In some embodiments, the recipient may utilize an RSS aggregator to subscribe to the audio feed (e.g., iTunes distributed by Apple, Inc.).

In an example embodiment, preference data associated with a recipient may be retrieved including a preferred listening device and the recorded data item may be transmitted to the preferred listening device. In some embodiments the recorded data item may be formatted to a format associated with the preferred listening device before being transmitted. In this manner if there are multiple recipients, each recipient will receive the recorded data item in a proper format.

FIG. 18 is a diagram illustrating example connections and functionality between example webpages, according to an example embodiment. Illustrated are many of the components described above, but from a user interface perspective. For example, a user may initially be presented with an information webpage with a title for the system such as “Read and Send.” In addition, the informational webpage may provide a first impression to visitors to the website. This first impression may include differentiations between the system and other products as well as providing example uses. For example, it may show a grandparent recording a book for his or her grandchild or a parent who is overseas sending a recording back to his or her child. In an example embodiment, the informational webpage may be linked to other main webpages: Online Library, Instructions, Purchase, Account Information, and Download. Secondary webpages may also have connections to the informational webpage such as About Us, Contact Us, and Legal. Exemplary illustrations of the contents of these webpage are shown in FIGS. 9-16.

The instructions webpage may including one or more additional webpages related to information on how to record a book. The webpage may also include illustrations of each step to show the ease of use the system provides.

The Account Information webpage may include information relating to the credits available to a user, the bookshelf of the user, a recording studio, and links to the user's recordings. This information may represent the books the user has read and recorded. The bookshelf may allow a user to collect a link to books the user may wish to read or record in the future. In an example embodiment, a user must be authenticated in a login process before being granted access to the to the account information webpage. In some embodiments, portions of the account are made publicly available to enable a social community to develop. For example, the user's bookshelf might be available to the public so that people can see what books the user is interested in reading. Further, account information may be limited to a select group of individuals such as relatives or close friends. The select group of individuals may further be able to comment, leave suggestions, or rank books on the user's bookshelf.

The Online Library webpage may including information related to books available to record, details of the books, as well as a list of books unavailable for recording. A user may add a book to the user's bookshelf or recommend a book to another user.

The Purchase webpage may allow a user to purchase a book as well as record and send it to a recipient. In an example embodiment, a user may login using a guest account to record the audio. A user may also see a list of recommended books or books related to a promotional program such as a book of the month club. A previously registered user may also have the option to not record the book, but save it for later.

The Download webpage may allow users and recipients to download the recorded audio, listen to recorded audio, and see additional book details. In some embodiments the webpage provides an embedded audio player that allows users and recipients to listen to recorded books without any additional software. The webpage may also provide previews of digital representations of the book as to allow a recipient to read a portion of the book before deciding whether or not to download the book.

### A Computer System

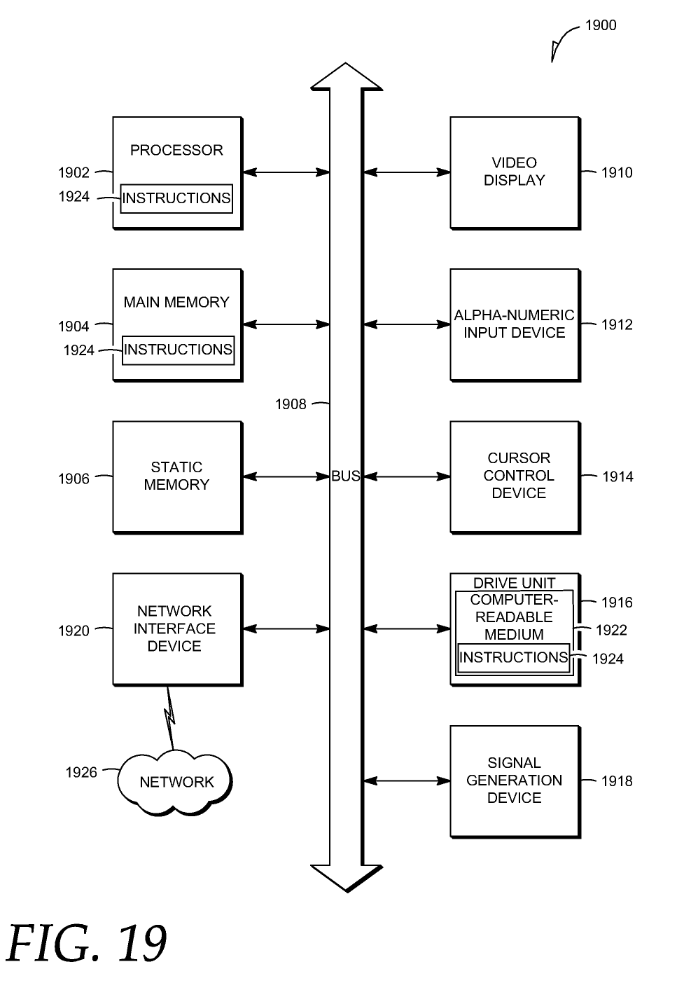

FIG. 19 shows a diagrammatic representation of a machine in the example form of a computer system 1900 within which a set of instructions for causing the machine to perform any one or more of the methodologies discussed herein may be executed. In alternative embodiments, the machine operates as a stand-alone device or may be connected (e.g., networked) to other machines. In a networked deployment, the machine may operate in the capacity of a server or a client machine in a server-client network environment or as a peer machine in a peer-to-peer (or distributed) network environment. The machine may be a Personal Computer (PC), a tablet PC, a Set-Top Box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems which are linked (e.g., either by hardwired, wireless, or a combination of hardwired and wireless connections) through a network both perform tasks. In a distributed system environment, program modules may be located in both local and remote memory-storage devices (see below).

The example computer system 1900 includes a processor 1902 (e.g., a Central Processing Unit (CPU), a Graphics Processing Unit (GPU) or both), a main memory 1904 and a static memory 1906, which communicate with each other via a bus 1908. The computer system 1900 may further include a video display unit 1910 (e.g., a Liquid Crystal Display (LCD) or a Cathode Ray Tube (CRT)). The computer system 1900 may also include an alphanumeric input device 1912 (e.g., a keyboard), a User Interface (UI) cursor controller (e.g., a mouse), a disc drive unit 1916, a signal generation device 1918 (e.g., a speaker) and a network interface device (e.g., a transmitter) 1920.

The disc drive unit 1916 includes a machine-readable medium 1928 on which is stored one or more sets of instructions 1917 and data structures (e.g., software) embodying or utilized by any one or more of the methodologies or functions illustrated herein. The software may also reside, completely or at least partially, within the main memory 1904 and/or within the processor 1902 during execution thereof by the computer system 1900, the main memory 1904 and the processor 1902 also constituting machine-readable media.

The instructions 1917 may further be transmitted or received over a network (e.g., the INTERNET) 1926 via the network interface device 1920 utilizing any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more methodologies illustrated herein. The term “machine-readable medium” shall accordingly be taken to include, but not be limited to, solid-state memories, and optical and magnetic medium.

What is claimed is:

1. A method comprising:
generating a user interface, wherein the user interface comprises audio data and video data received from a first user device and audio data and video received from a second user device,
receiving a selection of a book from the first user device;
displaying a graphical representation of the book comprising text and illustrations from the book on the user interface, wherein the book is presented a single page at a time;
receiving an indication from the first user device or second user device to proceed to another page of the book;
updating the user interface to present the second page of the book; and
transmitting the user interface to the first user device and the second user device.

2. The method of claim 1, further comprising:
receiving a selection of at least one participant, wherein the first user device transmits cursor input from the at least one participant.

3. The method of claim 1, further comprising:
embedding an interactive control on one or more pages of the book;
receiving an activation of the interactive control, wherein a series of discussion points are presented on the user interface upon the activation of the interactive control.

4. The method of claim 1, further comprising:
receiving cursor input information from the first user device; and
presenting the cursor input information on the user interface.

5. The method of claim 1, further comprising:
receiving a preference of a user device to control the user interface; and
configuring the user interface to restrict control of the user interface to the user device specified in the preference.

6. The method of claim 1, further comprising:
displaying a guided reading indicator on the user interface, wherein the guided reading indicator moves at a predetermined pace across the text of the book.

7. The method of claim 1, further comprising:
displaying a guided reading indicator on the user interface, wherein the guided reading indicator is synced with the audio data from the first user device or the second user device.

8. A system comprising:
a network interface device to receive audio data from a first user device and to receive audio data from a second user device;
a processor;
one or more computer programs executed on the processor to:
generate a user interface including the audio data from the first user device and audio data from the second user device;
receive a selection of a book from the first user device;
display a graphical representation of the book comprising text and illustrations from the book on the user interface, wherein the book is presented two pages at a time;
receive an indication from the first user device or second user device to proceed to a second portion of the book;
update the user interface to present the second portion of the book; and
transmit the user interface to the first user device and the second user device.

9. The method of claim 7, wherein the one or more programs executed on the processor are to:
receive a selection of at least one participant, wherein the first user device transmits cursor input from the at least one participant.

10. The method of claim 7, wherein the one or more programs executed on the processor are to:
embed an interactive control on one or more pages of the book;
receive an activation of the interactive control, wherein a series of discussion points are presented on the user interface upon the activation of the interactive control.

11. The method of claim 7, wherein the one or more programs executed on the processor are to:
receive cursor input information from the first user device; and
present the cursor input information on the user interface.

12. The method of claim 7, wherein the one or more programs executed on the processor are to:
receive a preference of a user device to control the user interface; and
configure the user interface to restrict control of the user interface to the user device specified in the preference.

13. The method of claim 7, wherein the one or more programs executed on the processor are to:
display a guided reading indicator on the user interface, wherein the guided reading indicator moves at a predetermined pace across the text of the book.

14. The method of claim 7, wherein the one or more programs executed on the processor are to:
display a guided reading indicator on the user interface, wherein the guided reading indicator is synced with the audio data from the first user device or the second user device.

15. A machine-readable medium with instructions stored thereon, which when executed by a processor perform a method, the method comprising:
generating a user interface, wherein the user interface comprises audio data and video data received from a first user device and audio data and video received from a second user device,
receiving a selection of a book from the first user device;
displaying a graphical representation of the book comprising text and illustrations from the book on the user interface, wherein the book is presented a single page at a time;
receiving an indication from the first user device or second user device to proceed to a second page of the book;
updating the user interface to present the second page of the book; and
transmitting the user interface to the first user device and the second user device.

16. The machine-readable medium of claim 15, the method further comprising:
embedding a hotspot on a page of the book, wherein the hotspot is associated with prerecorded audio.
